(19) United States
(12) Patent Application Publication
(10) Pub. No.: US 2015/0176627 A1
(43) Pub. Date: Jun. 25, 2015

(54) Method for captive application of a support washer on the shaft of a screw

(71) Applicant: RICHARD BERGNER VERBINDUNGSTECHNIK GMBH & CO. KG, SCHWABACH (DE)

(72) Inventors: WILHELM SCHNEIDER, REDNITZHEMBACH (DE); HELMUT WIERZBA, SCHWABACH (DE)

(21) Appl. No.: 14/573,103

(22) Filed: Dec. 17, 2014

(30) Foreign Application Priority Data
Dec. 17, 2013 (DE) 10 2013 021 036.4

(51) Int. Cl. F16B 33/06; F16B 43/00

(52) U.S. Cl. CPC F16B 33/06; F16B 43/00

(57) ABSTRACT

A method produces a fastener unit which has a fastener with a shank and with a head projecting radially beyond the shank and has a disk through which a central passage opening extends. On the shank, there is provided a radially projecting engage-behind element. The method includes providing a disk blank having a passage opening, a diameter of which passage opening is larger than the diameter of the engage-behind element. The shank already equipped with a fixing element is inserted so far into the passage opening that the passage opening is extended through by a first shank section extending away from the head. The passage opening is reduced in size, so as to form a radial overlap between the engage-behind element and an edge region of the disk, by radially inwardly directed plastic deformation of at least a part of the edge region of the disk blank.

The invention relates to a method for producing a fastener unit which comprises a fastener, for example a screw, and a washer, hereinafter referred to for short as disk. The fastener has a shank and a head projecting radially beyond said shank. A central passage opening extends through the disk, said central passage opening being extended through by the shank of the screw or of the fastener and thus being non-detachably connected to the fastener. The shank is divided into a first shank section, which extends away from the head and which extends through the passage opening of the disk, and a second shank section, which adjoins said first shank section and which is equipped on its circumference with a fixing element, in particular a thread. The non-detachable fixing of the disk to the fastener is realized firstly by the head of said fastener, which radially at least partially overlaps the disk, and secondly by an engage-behind element which projects radially from the shank. Said engage-behind element is, on its side facing toward the head, engaged behind or radially overlapped by the edge region, bordering the passage opening, of the disk. The engage-behind element is in this case formed by the second shank section, which bears the fixing element or the thread.

Fastener units of the described type are used for example when it is necessary for components composed of relatively soft materials to be connected to another component, if a component to be fixed has large fixing bores through which the fastener extends in the assembled state or if sealed or vibration-damped fixing is to be realized.

To produce the fastener units in question, use is normally made of a fastener blank with a shank which does not yet have a fixing element, for example a thread. A disk is pushed onto the shank, and then the fixing element, for example a thread, is rolled into the outer circumference of the shank, wherein that part of the shank which bears the fixing element forms the second shank section. Said second shank section has a larger diameter than the first shank section situated between it and the head, which first shank section extends through the passage opening of the disk. By contrast, the diameter of the disk is smaller than the diameter of the second shank section, such that after the production of the fixing element, said disk is non-detachably connected to the fastener.

The conventional method for producing a fastener unit is a problem if it is sought to use fasteners of a higher strength rating. The higher material strength is attained by a hardening and tempering treatment which is performed after the thread, or generally a fixing element, has been rolled in. In the case of a fastener unit of the present type, however, under the conditions of a hardening and tempering treatment carried out with regard to the material of the fastener, the characteristics profile of the material of the disk would change; in particular, the disk would lose its strength. It is therefore normally the case that a screw blank which does not yet have a fixing element is subjected to a hardening and tempering treatment and, after the disk has been pushed on, the fixing element is rolled into the shank of the hardened and tempered fastener, and in the process, the disk is non-detachably connected to the fastener shank. Owing to the hardened and tempered material, which accordingly has a higher strength, of the fastener blank, this however involves increased outlay.

Furthermore, in the case of the conventional method for producing fastener units, surface treatment of the fastener, for example a surface treatment such as is performed at elevated temperature, cannot be performed if the disk comprises an elastomer element for example for sealing or damping purposes.

Taking this as a starting point, it is the object of the invention to propose a method for producing a fastener unit of the type mentioned in the introduction, by means of which method the stated problems can be circumvented.

Said object is achieved by means of a method as claimed in claim 1. In a method according to the invention, use is made not of a fastener blank but of a finished fastener which already has a fixing element. Furthermore, a disk blank having a passage opening is provided, the diameter of which passage opening is larger than the diameter of the engage-behind element. As a next method step, the shank of the fastener is inserted so far into the passage opening of the disk blank that said passage opening is at least partially extended through by the first shank section of the fastener shank. As a final method step, the passage opening of the disk blank is reduced in size by a radially inwardly directed plastic deformation or material displacement of at least a part of the edge region of said disk blank. As a result, the engage-behind element is at least partially radially overlapped, on its side facing toward the head, by the deformed edge region of the disk.

With the proposed approach, it is thus possible to use the finished fastener, that is to say the fastener that has already been equipped with a fixing element and which has if appropriate already been subjected to hardening and tempering or a surface treatment, such that the above-mentioned disadvantages arising from the combination of fastener blank and disk are circumvented. The rolling of the fixing element into a fastener blank can be performed, with low outlay, into the material which has not yet been subjected to hardening and tempering and which therefore has a lower strength than the finished fastener. A surface treatment of the fastener can be performed without impairment of the disk.

The invention will now be explained in more detail with reference to the appended drawings, in which:

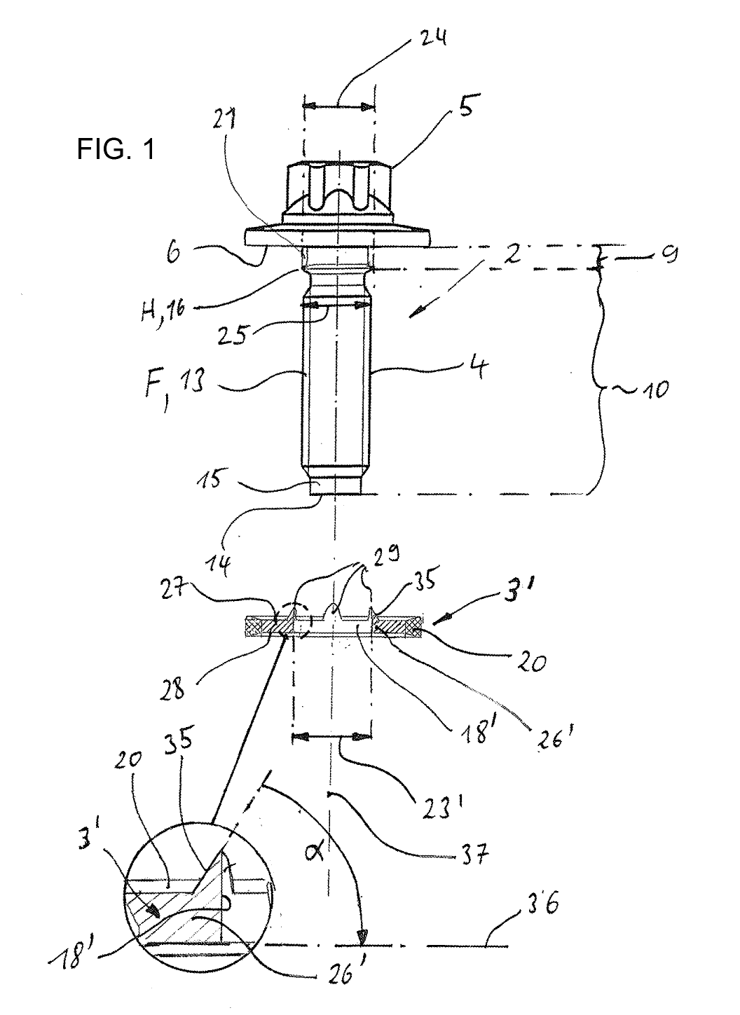

FIG. 1 shows a fastener in a side view and a disk blank in a sectional illustration,

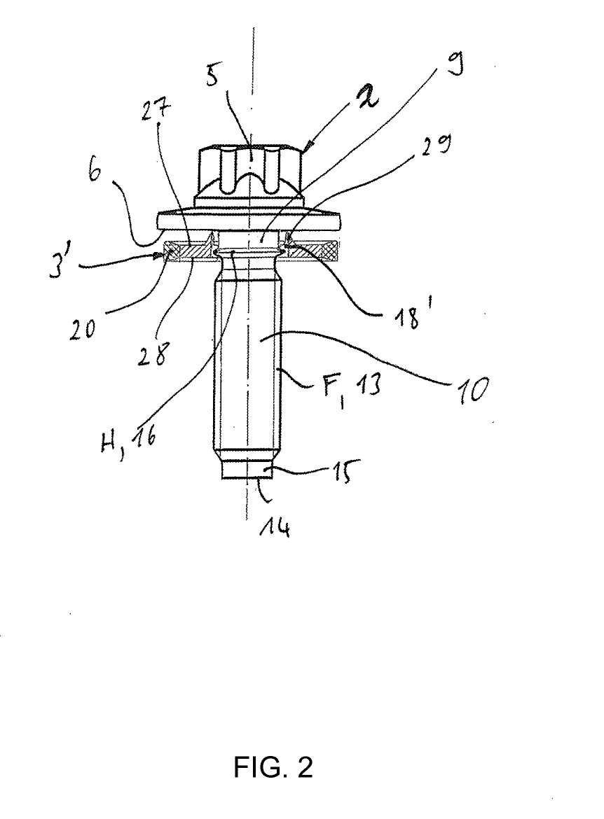

FIG. 2 shows a pre-assembled state in which a central passage opening of the disk blank is extended through by the shank of the fastener,

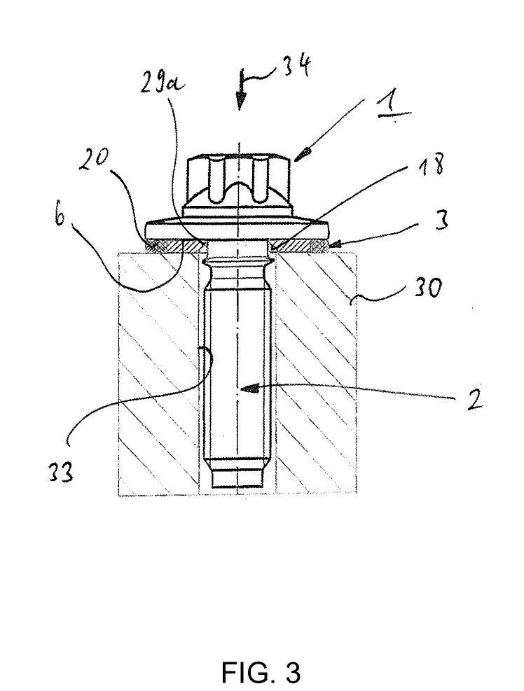

FIG. 3 is an image showing the fixing of the disk blank to the fastener shank,

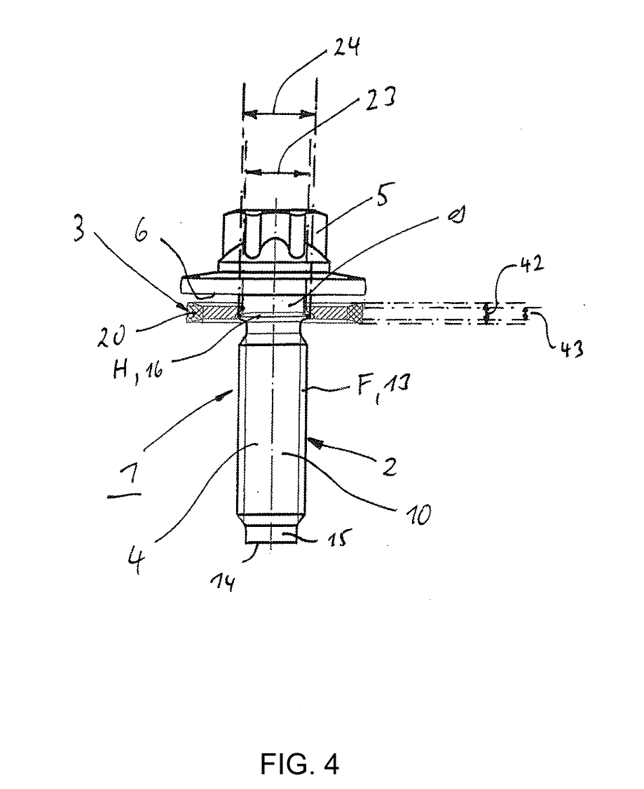

FIG. 4 shows a fastener unit with a fastener and with a disk non-detachably fixed to the shank thereof,

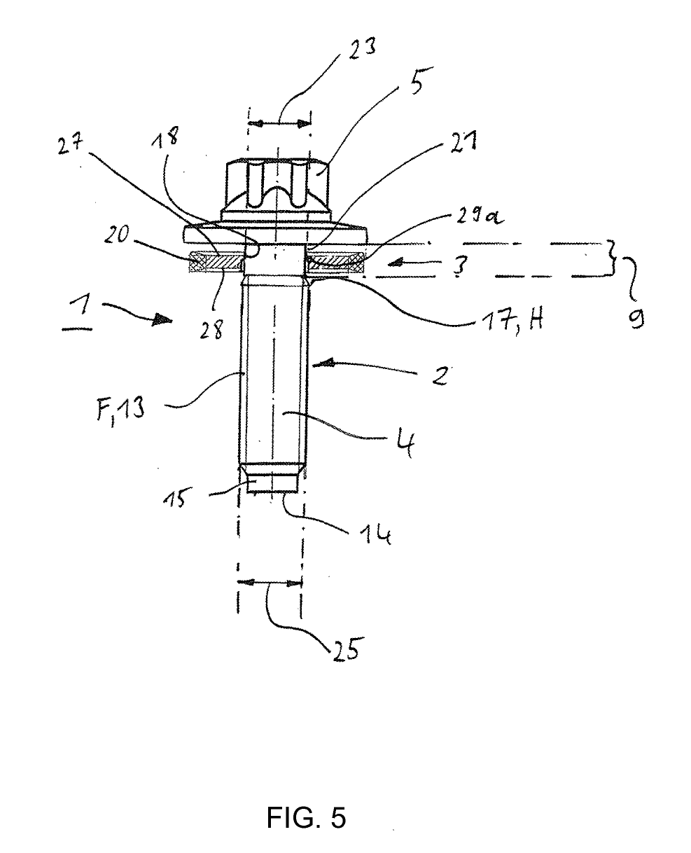

FIG. 5 shows a fastener unit of an alternative design,

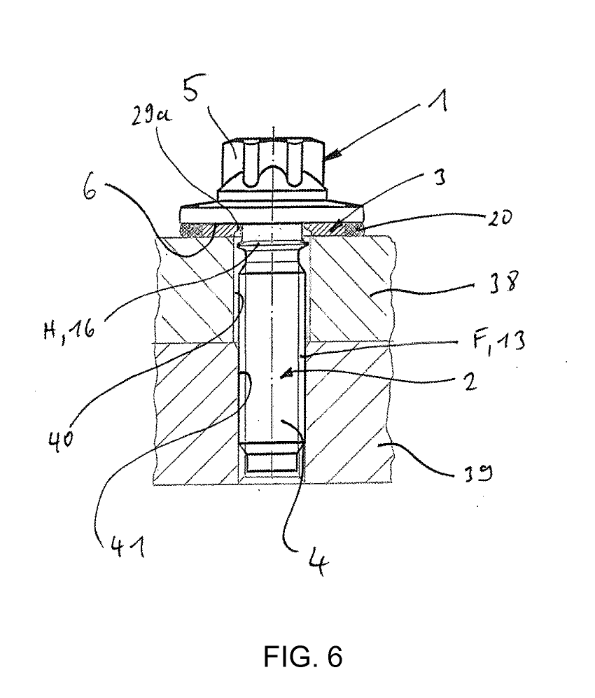

FIG. 6 shows, in a partially sectional view, two components connected to one another by means of a fastener unit as per FIG. 4.

A fastener unit 1 illustrated by way of example in FIGS. 4 and 5 comprises a fastener 2 and a washer or disk 3. The fastener has a shank 4, on one end of which there is integrally formed a head 5. The head 5 or the head underside 6 thereof projects radially beyond the shaft circumference.

The shank 4 is divided into two different longitudinal sections, specifically a first shank section 9 extending away from the head 5 or from the head underside 6, and a second shank section 10 adjoining said first shank section. On its circumference, the second shank section 10 is equipped with a fixing element F which, in the exemplary embodiments shown in the figures, is a thread 13. The fixing element F or the thread 13 may extend as far as that end 14 of the shank 4 which is remote from the head, or may end at an axial distance therefrom, as is the case in the exemplary embodiments that are shown. That longitudinal section of the shank which extends from the fixing element to the end 14 is then expediently in the form of a locating tip 15. The shank 4 has an engage-behind element H which projects radially beyond the shaft circumference of the first shank section 9. The engage-behind element H is formed for example by an annular projection 16 (FIGS. 1-4, 6) arranged between the head 5 and the second shank section 10 or by the head-side end 17 of the fixing element F (FIG. 5).

The disk 3 and a disk blank 3′ which serves for the production of the fastener unit 1 have a central passage opening 18, 18′. An elastomer ring 20 is fixed to the outer edge thereof. The diameter 23′ of the passage opening 18′ of the disk blank 3′ is larger than the diameter of the engage-behind element H, that is to say is larger than the diameter 25 of the fixing element F (FIG. 5) or larger than the diameter 24 of the annular projection 16 (FIG. 4).

To produce the fastener unit 1, the fastener 2 that has already been equipped with a fixing element F on its second shank section 10 is inserted so far into the passage opening 18′ of the disk blank 3′ that said passage opening is at least partially extended through by the first shank section 9 of the shank 4. The axially fixed or non-detachable fixing of the disk 3 to the shank 4 is realized by radially inwardly directed plastic deformation of the edge region 26′, bordering the passage opening 18′, of the disk blank 3′. The plastic deformation, which may encompass the entire edge region 26 or only parts thereof, for example sections which are spaced apart in a circumferential direction, causes the passage opening 18′ to be reduced in size such that the—plastically deformed—edge region 26 of the disk 3 at least partially radially overlaps the engage-behind element H on its side facing toward the head 5. In other words, after the plastic deformation, the deformed edge region 26 of the disk 3 projects at least partially into the engage-behind space 21 (FIGS. 1, 5) which extends between the engage-behind element H and the head underside 6. The smallest radial dimension or the diameter 23 of the passage opening 18 is then smaller than the diameter 24 of the annular projection 16, or in FIG. 5, smaller than the diameter 25 of the fixing element F. The radially inwardly directed plastic deformation of the edge region 26′ of the disk blank 3′ is performed to such an extent that, in the fully assembled state as per FIG. 4 or 5, there is no radial play between the disk 3 and the first shank section 9. This has the advantage, in particular in the case of a sealing disk 3, that the disk 3 is arranged concentrically with respect to the screw head 5, and a uniform pressure distribution or sealing function is thus attained in the braced state as per FIG. 6.

During the plastic deformation in question, the material of the edge region 26′ of the disk blank 3′ is displaced radially inward. To ensure this, it is advantageous if the edge region 26′ has at least one radially inwardly plastically deformable deformation element 29 which projects in raised form from at least one face side 27, 28 of the disk blank 3′. In this case, the at least one deformation element 29 preferably projects from that face side 27 of the disk blank 3′ which faces toward the head 5. For the plastic deformation of the at least one deformation element 29, a counter bracket 30 with a receiving bore 33 for the fastener shank 4 is used. The shank 4 of the fastener 2 is inserted into the receiving bore 33, and the head 5 is subjected to a force in the direction of the arrow 34. In this way, the at least one deformation element 29 is acted on in the axial direction by the head underside 6 and, in the process, is bent and plastically deformed radially inwardly into the engage-behind space 21. If, as is preferably the case, the at least one deformation element 29 is arranged on that face side 27 of the disk blank 3′ which faces toward the head 5, it can be easily radially inwardly deformed to such an extent that it makes contact with the circumference of the first shank section 9. In the case of the deformation element 29 being arranged on that face side 28 of the disk blank 3′ which faces away from the head, such a deformation would not be readily possible owing to the engage-behind element H projecting radially beyond the circumference of the first shank section 9.

The at least one deformation element 29 is formed very generally by a material accumulation in the edge region 26′ of the disk blank 3′ and is for example in the form of an encircling bead (not shown) which projects in raised form from a face side 27, 28. In the exemplary embodiments shown, multiple deformation elements 29 are provided which are spaced apart in the circumferential direction of the edge region 26′ and which are formed as individual projections. The passage opening 18 of the disk is in this case narrowed by the radially inwardly bent—deformed—deformation elements 29a, wherein the latter—as described—radially overlap the annular projection 16 or the fixing element. The radially inwardly directed plastic deformation of a deformation element 29 is facilitated by virtue of the fact that said deformation element has an oblique surface 35 which, with the plane 36 spanned by the disk blank 3′, forms an acute angle a which opens toward the central longitudinal axis 37 of the disk blank 3′.

FIG. 6 shows an exemplary embodiment in which a first component 38 is connected by means of a fastener unit 1 to a second component 39. Here, the shank 4 of the fastener 2 extends through a bore 40 in the first component 38 and engages by way of its thread 13 into a counterpart thread 41 in the second component 39. The disk 3 is pressed against the first component 38 by the fastener head 5. If, as in the example shown, the disk is equipped with an elastomer ring 20, said elastomer ring expediently has a thickness 42 greater than the thickness 43 of the disk 3 (see FIG. 4). The elastomer ring 20, in the unloaded state, projects from at least one of the face sides 27, 28 of the disk 3; said elastomer ring, in the loaded state or when the fastener 2 has been tightened, is compressed axially so as to seal the gaps between the disk 3 and the head 5 and the first component 38 respectively.

### LIST OF REFERENCE NUMERALS

1 Fastener unit

2 Fastener

3 Disk

3′ Disk blank

4 Shank

5 Head

6 Head underside

7 Diameter (of 5)

8 Diameter (of 4)

9 First shank section

10 Second shank section

13 Thread

14 End

15 Locating tip

16 Annular projection

17 Head-side end (of F)

18 Passage opening

20 Elastomer ring

21 Engage-behind space

23 Diameter (of 18)

24 Diameter (of 16)

25 Diameter (of F)

26 Edge region

27 Face side

28 Face side

29 Deformation element

30 Counter bracket

33 Receiving bore

34 Arrow

35 Oblique surface

36 Plane

37 Central longitudinal axis

38 Component

39 Component

40 Bore

41 Counterpart thread

42 Thickness

43 Thickness

1-10. (canceled)

11. A method for producing a fastener unit having a fastener with a shank, a head projecting radially beyond the shank and a disk having a central passage opening formed therein, the shank having a first shank section extending away from the head and extending through the central passage opening and a second shank section, adjoining the first shank section and equipped with a fixing element on a shank circumference of the second shank section, and on the shank, there is provided an engage-behind element projecting radially beyond a shank circumference of the first shank section and being at least partially radially overlapped by an edge region, bordering the central passage opening, of the disk on a side facing toward the head, which comprises the following steps of:
providing the fastener having the first shank section and the second shank section already equipped with the fixing element;
providing a disk blank having the central passage opening, a diameter of the central passage opening being larger than a diameter of the engage-behind element;
inserting the fastener so far into the central passage opening that the central passage opening being extended through by the first shank section; and
reducing in size the central passage opening so as to form a radial overlap, by radially inwardly directed plastic deformation of at least a part of an edge region of the disk blank.

12. The method according to claim 11, which further comprises providing the fastener with the engage-behind element functioning as the fixing element disposed on the second shank section.

13. The method according to claim 11, which further comprises forming the fastener with the engage-behind element which projects radially beyond the shank circumference of the second shank section.

14. The method according to claim 13, which further comprises providing the fastener with the engage-behind element formed as an annular projection.

15. The method according to claim 13, which further comprises forming the engage-behind element disposed between the first shank section and the second shank section.

16. The method according to claim 11, which further comprises forming the disk blank having the edge region bordering the central passage opening with at least one deformation element which protrudes in a raised form from at least one face side of the disk blank and which is radially inwardly plastically deformable.

17. The method according to claim 16, which further comprises forming the at least one deformation element to project in raised form from the at least one face side of the disk blank which faces toward the head.

18. The method according to claim 16, which further comprises forming the disk blank with a plurality of deformation elements which are spaced apart in a circumferential direction of the edge region.

19. The method according to claim 16, which further comprises forming at least one of the deformation elements with an oblique surface which, with a plane spanned by the disk blank, encloses an acute angle which opens toward a central longitudinal axis of the disk blank.

20. The method according to claim 11, which further comprises performing a radially inwardly directed plastic deformation of at least a part of the edge region of the disk blank such that the disk is fixed to the first shank section without radial play.
